(19) United States
(12) Patent Application Publication
(10) Pub. No.: US 2010/0249996 A1
(43) Pub. Date: Sep. 30, 2010

(54) AUTOMATIC VENDING MACHINE FOR LIGHT BULBS

(75) Inventors: CHIH-CHUNG TSAO, Chu-Nan (TW); SHAN-JU LIN, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/627,020

(22) Filed: Nov. 30, 2009

(30) Foreign Application Priority Data
Mar. 31, 2009 (CN) 200910301249.5

(51) Int. Cl. G06F 17/00; G06F 17/30; G06F 3/02; G06F 15/00

(52) U.S. Cl. 700/233; 707/792; 345/168; 702/182; 707/E17.044

(57) ABSTRACT

An automatic vending machine for light bulbs includes an assembling system and a user interface. The assembling system includes a component depository. The component depository is used for storing various components of the light bulbs, inclusive of various light sources and various bulb envelopes. The user interface includes a display terminal and an input terminal. The display terminal is used to show parameters of the light bulbs. The input terminal is used for consumers to input selected parameters of the light bulbs according to their demand. The assembling system is used for receiving the selected parameters and assembling a selected light bulb corresponding to the selected parameters.

### BACKGROUND

1. Technical Field

The present disclosure generally relates to vending machines for light bulbs, and particularly to vending machines for bulbs, wherein the vending machines have versatile functions.

2. Discussion of Related Art

Nowadays, consumers select light bulbs is usually according to the appearance, but they don't know the working parameters of the light bulbs, such that the selected light bulbs may be not the consumers wants and needs. Also, with the continuing development of scientific technology, automated light bulbs vending machines have been proposed. However, the proposed light bulbs vending machines have only one function: selling the light bulbs along; they lack value-added features to satisfy consumer's requirements in purchasing the light bulbs.

Therefore, what is needed is an automatic vending machine for light bulbs is capable of overcoming the above described shortcomings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout certain views.

FIG. 1 is a block diagram of an automatic vending machine for light bulbs in accordance with a first embodiment of the present disclosure, in connection with a user input.

FIG. 2 is a block diagram of an automatic vending machine for light bulbs, in accordance with a second embodiment of the present disclosure, in connection with a user input.

### DETAILED DESCRIPTION OF EMBODIMENTS

Reference will now be made to the drawings to describe embodiments of the present automatic vending machine for light bulbs, in detail.

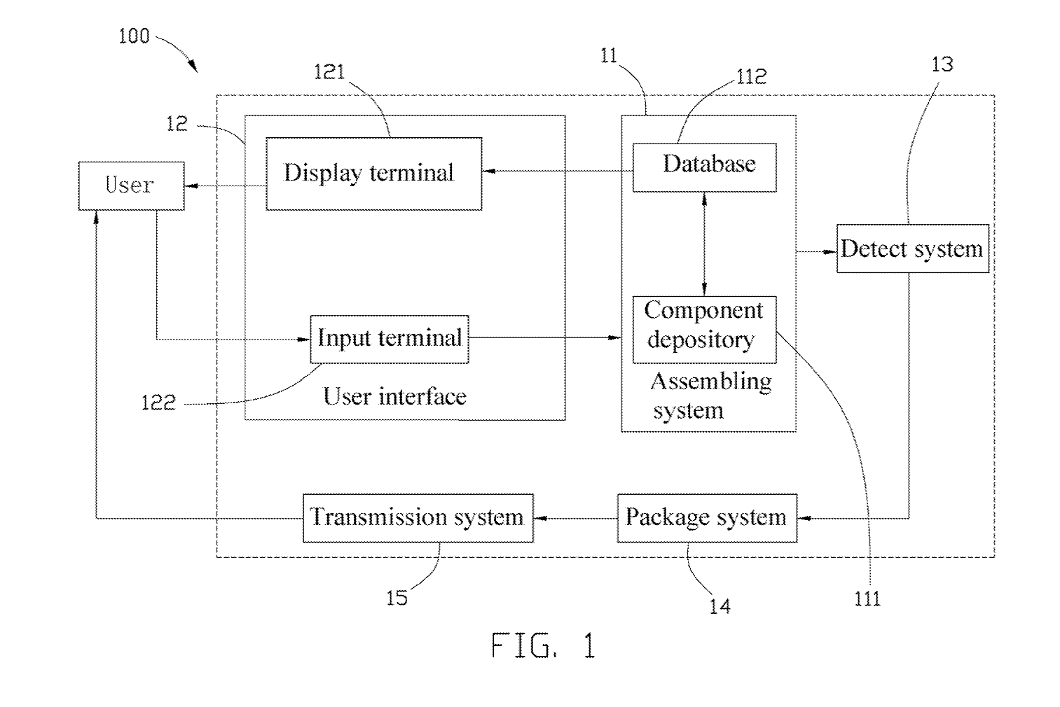

Referring to FIG. 1, an automatic vending machine for light bulbs 100, according to a first exemplary embodiment, includes an assembling system 11 and a user interface (also known as human computer interface or man-machine interface (MMI)) 12. The automatic vending machine 100 is particularly for vending LED bulbs, each of which has LEDs (light emitting diodes) as light source.

The assembling system 11 includes a component depository 111 and a database 112. The component depository 111 stores various components of the light bulbs, such as bulb envelopes and light sources. The bulb envelopes have different colors, shapes or materials, and the light sources have different colors, brightness and electric power consumptions or other parameters. The database 112 stores parameters corresponding to the various components of the light bulbs stored in the component depository 111. In the present embodiment, the parameters include different materials, shapes, colors of the bulb envelopes, different colors, brightness and electric power consumptions of the light sources, and different working parameters of the light bulbs assembled with different bulb envelopes and different light sources, and so on. It can be understood that the data stored in the database 112 can be updated in time according to the update of components stored in the component depository 111.

The user interface 12 has a display terminal 121 and an input terminal 122. The display terminal 121 is used for showing parameters by pictures or by letters according to the various components stored in component depository 111. In the present embodiment, the display terminal 121 can be a cathode ray tube (CRT), a liquid crystal display (LCD), and so on. The display terminal 121 is used for showing information regarding the different materials, shapes, different colors of the bulb envelopes; the different colors, brightness and electric power consumptions of the light sources, and the different parameters of light bulbs assembled with different bulb envelopes and different light sources, and so on. Furthermore, the display terminal 121 can show a data matrix of the bulb envelopes and the light sources whereby the consumer can easily decide the desired combination of the assembled light bulb that he (she) wants to purchase.

The user inputs parameters of the light bulbs according to his (her) demands by the input terminal 122. The input terminal 122 can be selected from the group consisting of keyboard, keypad, touch panel, etc, which connects with the assembling system 11 via a wireless data transmission or a wire data transmission having a universal serial bus (USB) port.

The user interface 12 sends an assembling signal including different parameters to the assembling system 11, and the assembling system 11 receives the assembling signal and assembles selected ones of the bulb envelopes and light sources corresponding to the parameters.

In the present embodiment, the automatic vending machine for light bulbs 100 further comprises a detect system 13, a package system 14 and a transmission system 15.

The detect system 13 is connected to the assembling system 11 and used for detecting reliability of the light bulbs after assembled. When the light bulbs after assembled are qualified, the detect system 13 sends a packaging signal to the package system 14. When the light bulbs after assembled are unqualified, the detect system 13 sends an assembling signal to the assembling system 11, and the assembling system 11 assembles another light bulb according to the parameters again.

The package system 14 is used for packing the qualified light bulbs after detected by the detect system 13 and sending them to the transmission system 15. The transmission system 15 is used for transmitting the light bulb after packaged to the users.

The automatic vending machine for light bulbs 100 can assemble light bulbs according to the demand of the consumers instantly and accurately. The automatic vending machine for light bulbs 100 is more convenient.

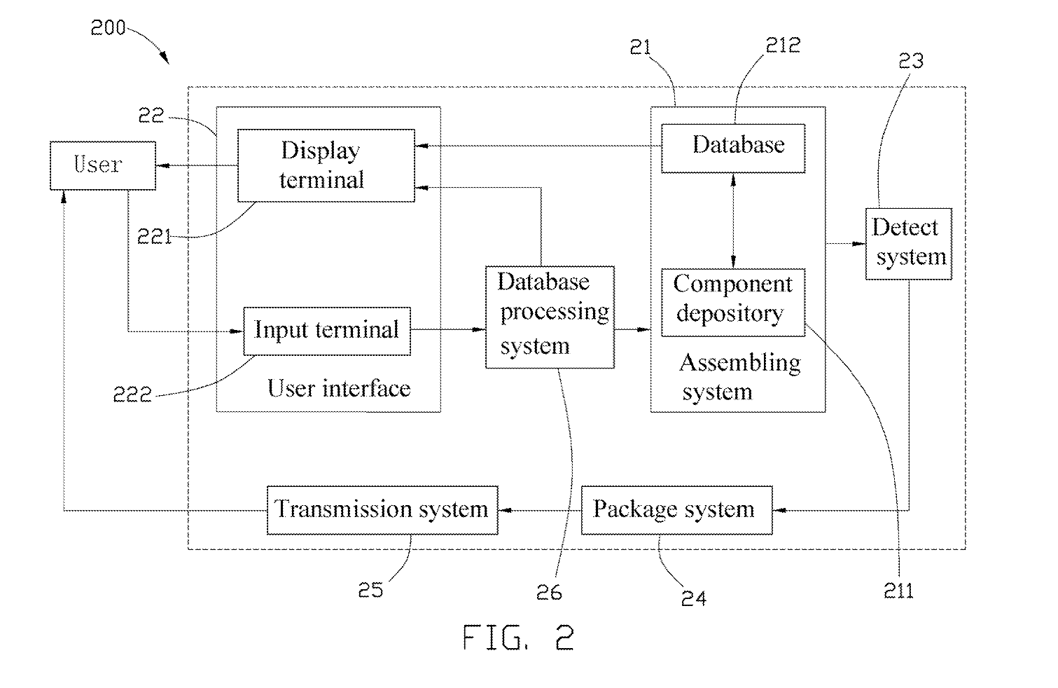

Referring to FIG. 2, an automatic vending machine for light bulbs 200, according to a second exemplary embodiment, includes an assembling system 21 and a user interface 22. The automatic vending machine for light bulbs 200 has a configuration similar to that of the automatic vending machine for light bulbs 100. The main difference is that the automatic vending machine for light bulbs 200 includes a database processing system 26.

The database processing system 26 is used for disposing the parameters inputted by the consumer and sending a signal to the assembling system 21. The assembling system 21 assembles light bulbs corresponding to the signal. In the present embodiment, the database processing system 26 outputs a virtual image of the selected light bulb assembled with the selected light source and the selected bulb envelope to the display terminal 221 according to the parameters inputted by the consumer. By the virtual image the consumer can have a visional impression of the assembled light bulb in advance to decide whether he (she) really wants to purchase the selected light bulb. After the consumer confirms, the database processing system 26 sends a signal to the assembling system 21, the assembling system 21 assembles light bulbs corresponding to the signal. In the present embodiment, when the consumers cancel or do not confirm, after a predetermined time, the consumers can input new parameters again.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An automatic vending machine for light bulbs comprising:
an assembling system comprising a component depository, the component depository being used for storing various components of the light bulbs;
a user interface comprising a display terminal and an input terminal, the display terminal being used to show parameters of the light bulbs, the input terminal being used for consumers to input selected parameters of the light bulbs according to consumers demands, the assembling system being used for receiving the selected parameters and assembling a selected light bulb corresponding to the selected parameters.

2. The machine of claim 1, wherein the assembling system further comprising a database, the database is used for storing data corresponding to the various components of the light bulbs stored in the component depository.

3. The machine of claim 1, wherein the input terminal can be selected from the group consisting of keyboard, key pad and touch panel which connects with the assembling system via one of wireless data transmission and wire data transmission having a universal serial bus port.

4. The machine of claim 1, further comprising a detect system, the detect system is used for detecting reliability of the selected light bulb after assembled by the assembling system.

5. The machine of claim 4, further comprising a package system, the package system is used for packing the selected light bulb after it is detected by the detect system and proved to be qualified.

6. The machine of claim 5, further comprising a transmission system, the transmission system is used for transmitting the selected light bulb after packaged.

7. The machine of claim 1, wherein the user interface further comprising a database processing system, the database processing system is configured for disposing the selected parameters inputted by the consumers and sending a signal to the assembling system, the assembling system assembles the selected light bulb corresponding to the signal.

8. The machine of claim 7, wherein the database processing system outputs a virtual image of a light bulb to the display terminal according to the selected parameters inputted by the consumers, and wherein when the virtual image is confirmed by the consumers, the database processing system sends the signal to the assembling system and the assembling system assembles the selected light bulb corresponding to the signal.

9. The machine of claim 1, wherein the components of the light bulbs comprise bulb envelops and the parameters comprise different materials, colors and shapes of the bulb envelopes.

10. The machine of claim 1, wherein the components of the light bulbs comprise light sources and the parameters comprise different colors, brightness and electric power consumptions of the light sources.

11. The machine of claim 1, wherein the parameters comprise working parameters of the light bulbs assembled with different bulbs envelopes and different light sources.

12. The machine of claim 1, wherein the light bulbs are LED light bulbs.

13. The machine of claim 11, wherein the light sources are LED light sources.
